(19) United States
(12) Patent Application Publication
(10) Pub. No.: US 2011/0283887 A1
(43) Pub. Date: Nov. 24, 2011

(54) GAS CLEANER

(76) Inventor: Bengt Eggemar, Vallingby (SE)

(21) Appl. No.: 13/147,490

(22) PCT Filed: Feb. 2, 2010
(86) PCT No.: PCT/SE10/50121

§ 371 Date: Aug. 2, 2011

(30) Foreign Application Priority Data
Feb. 4, 2009 (SE) 0900131-4

(51) Int. Cl. B01D 47/04

(52) U.S. Cl. 96/256

(57) ABSTRACT

Gas cleaner for removal of gas-borne particles with the aid of a fluid, comprising a filter with at least two mixing chambers (4), where each mixing chamber (4) has a fluid uptake space (9) and a therein arranged atomizer (12) with holes (11) through which the gas is brought to pass to create a foam for removal of gas-borne particles.

### THE FIELD OF THE INVENTION

The present invention relates to a gas cleaner for removal of gasborne particles with the aid of a fluid.

### PRIOR ART

The demand for clean air is today very large, within the industry, for example semiconductor industry, food industry as well as within the medical/veterinarian medical field. Further, there are higher and higher demands on improved hygiene, not least when it comes to inhalation air in confined spaces.

Rooms and premises are filled with air that can contain different types of airborne particles. Larger particles can consist of dust of different types and come from a whole lot of different sources. Smaller particles can be plant pollen, bacteria and virus.

Air can be cleaned from dust, pollen and the like airborne particles with the aid of mechanical filters. Smaller particles such as spores, bacteria and viruses however require smaller mesh size in the filter, which however quickly is filled by larger particles such as dust.

At present, there are vacuum cleaner constructions in which the filter bag is replaced by a water bath, through which the air is taken and where particles of different size more or less efficient adheres to the water bath. For smaller particles such as bacteria and virus, it is known that these can be caught by small water drops in a sprayed water curtain, water fog, and thereafter be separated from the purified air.

Within butcheries, food industries, laboratories and hospitals it is important to reduce the amount of airborne, inorganic particles, as well as organic compounds and infectious agents. Also in airplanes, trains, office premises and houses, cleaning of the air is necessary or desired.

Every degree of air purification can be of great significance. For a greater degree of air purification, such as for pollen, spores, bacteria and virus, the complexity, cost and maintenance of the system increases.

Particles are a problem also when it comes to other types of gases or gas mixtures, for example crude gas from power gas generating plant and smoke gases from different types of combustion.

Thus, there exists a need for simple and preferably substantially maintenance-free gas cleaning systems that still are comparatively efficient within a broad spectrum for gasborne particles. Hereby, fluid-based systems are preferred above mechanical filters, since the small mesh sizes that are required to remove small particles, quickly are filled and must be changed.

### The Invention

One object of the present invention is to provide a gas cleaner for removal of gasborne particles in an efficient way without undesired effect on the composition of the gas and without demands on after-treatment of the gas.

This is accomplished with the device according to the invention such as it is defined in the independent claim.

Developments and preferred embodiments of the invention are defined in the subclaims.

### BRIEF DESCRIPTION OF DRAWING

The invention will be described closer below with reference to an illustrative embodiment of the gas cleaner according to the invention shown in the appended drawing, whereby

FIG. 1 shows a schematic view of an embodiment of the device according to the invention, and

FIG. 2 shows a schematic view from above of a cap with atomizer.

### DETAILED DESCRIPTION OF THE INVENTION

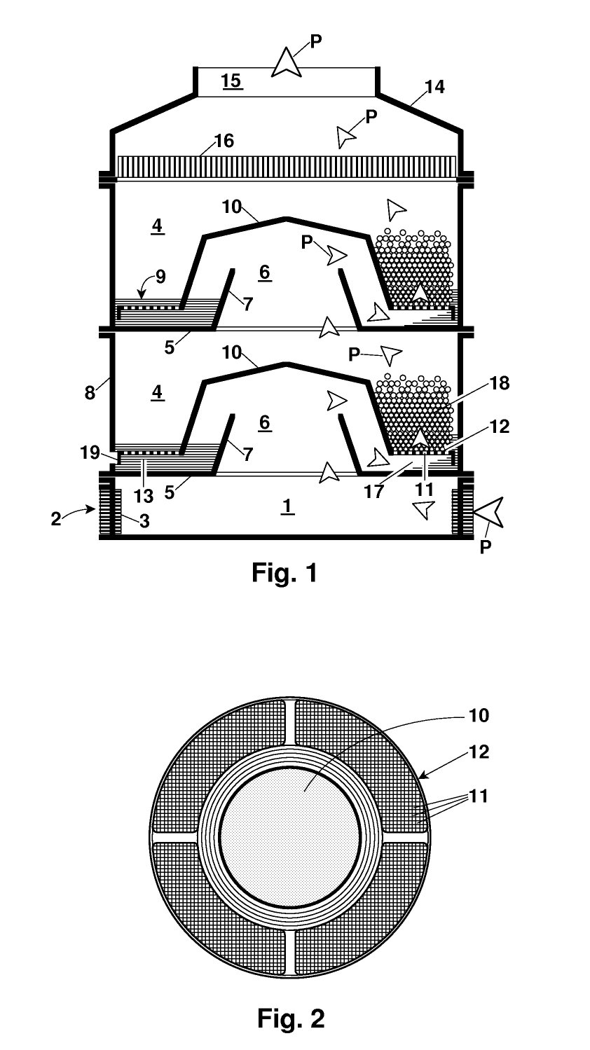

In FIG. 1 is shown schematically a first embodiment of a device according to the invention in the form of a filter with a base chamber 1 with a gas inlet 2 with a coarse filter 3.

After the base chamber 1, seen in the flow direction of the gas, are arranged at least two mixing chambers 4 in series after each other. The base 5 of the mixing chamber 4 constitute the base chamber 1 and upper delimiting wall of the underlying mixing chamber, respectively, and comprises a, preferably in the flow direction of the gas conically tapering, gas outlet 6, which leads out into the mixing chamber. The limitation wall 7 of the gas outlet, together with the wall 8 of the mixing chamber 4 delimits a fluid uptake space 9 in the mixing chamber.

In the mixing chamber 4 is arranged a cap 10, that is arranged over the gas outlet 6 and extends downwards at a distance outside and beyond the limitation wall 7 to a distance above the base of the mixture chamber in the fluid uptake space 9. At the lower edge of the cap, and connected with this, is in the shown embodiment arranged an atomizer 12 provided with holes 11 in the form of a hole disc.

In the fluid uptake space is arranged a fluid 13. The level of the fluid 13 is preferably above the atomizer 12, when the filter not is being used.

The filter further comprises a top piece 14, with a preferably conically tapering, seen in the flow direction of the gas, gas outlet opening 15, as well as a splash filter 16.

In FIG. 2 is shown a schematic view of the cap 10 with the ring-formed atomizer 12, arranged on its lower edge. The task of the atomizer is to atomize the gas so that it forms a foam with gas-filled bubbles, with the fluid. Instead of the disc provided with holes, shown in FIG. 1, the atomizer can consist of a net or grid with small mesh size, for example, as is implied in the figure, suspended in sections. The atomizer can also be manufactured from a material exhibiting through channels or which contains connected cavities in the material, through which the gas passes and is atomized.

The choice of the size of the passengers can depend on the liquid used, as well as on expected size of the particle-shaped impurities.

In the purification of gas with varying sizes of the particle-shaped impurities, the passage size of the atomizer in the mixing chambers connected in series can be constructed with decreasingly smaller sizes.

The flow of the gas is in FIG. 1 implied with arrows P. The gas that is to be purified is sucked or pressed by means of a fan or the equivalent, through the filter. Thereby part of the fluid 13 is pushed through the holes 11 in the atomizer 12, as is implied on the right hand side of the figure at 17. The gas flow is atomized to bubbles that with the fluid forms a foam 18. Thereby, gasborne particles adheres on the fluid surface on the inside and outside of the foam bubbles.

Because of pressure difference and because of gravitational force, the foam bubbles burst, whereby purified or partly purified gas is released.

Fluid from bursting foam with adhering dirt particles flows from the top of the foam out towards the periphery and then along the side of the foam and/or the wall 8 of the mixture chamber, back to the fluid storage 13 in the ring-formed chamber, over and under the holes exhibiting disc of the atomizer.

As is implied at 19, a border can be arranged at the outer periphery of the atomizer for improved capturing of gas that flows down in the fluid 13 in said fluid uptake space 9 through the gas outlet 6 and the gap between the cap 10 and the wall 7 surrounding the gas outlet, flows down in the fluid 13 in said fluid uptake space 9.

The fluid used in the filter can be chosen for optimum filter function for existing use conditions. The fluid can thus be water or oil or any other suitable fluid. In cases where it is desirable to avoid that the moisture content of the purified gas increases when passing through the filter, a fluid is preferably used that does not vaporize at the existing pressure and temperature, for example an oil, glycerol.

When using water, this can at suitable time intervals be replaced by clean water. When oil or other fluid with low steam pressure is used, this can preferably be drawn off continuously or when the filter does not work to a filter, which can be cleaned, and then be pumped back into the filter.

In the shown embodiment, the filter exhibits two mixing chambers. In cases where extremely small particles shall be removed, such as bacteria, virus etc., the filter can comprise an arbitrary number of mixing chamber steps.

It is also possible to arrange different types of fluids in the mutually subsequent mixing chamber steps.

The splash filter 16 can consist of multilayered thin meshes through which purified gas flows. In the filter, splashes of fluid from bursting foam bubbles are caught. The splash filter can also be electrically charged, or it can be combined with an electrostatic filter for breaking the surface tension of possible remaining fluid bubbles in the gas.

By using a fluid at air purification, that has a low steam pressure at the current air temperature, such as an oil, glycerin or other non toxic fluid, the great advantage is achieved that the moisture content of the air is not altered at the purification. By low steam pressure is in this context meant that the fluid is not vaporized at the existing pressure and temperature and thereby virtually does not exist in the purified air.

In, for example, countries and premises where the humidity already is so high or low that possible increased humidity is not a disadvantage, water is preferably used as fluid at the air purification. Thereby, it can be advantageous to add surfactants or other foam promoting additives to enhance the foam production.

To achieve a desired air humidity, water can be added to a fluid with low steam pressure in the filter. This might take place on the basis of the measured moisture content of the inflowing air, whereby simultaneously with the purification of the air, a controlled increased humidity can be achieved in for example a premise.

Fluid can advantageously be added in a final step in the filter, to gradually be drawn off to the closest underlying step, for example by a siphon effect so that the most clean fluid exists in the last step and the most contaminated fluid exists in the first step where the largest particles in the contaminated air are caught. The fluid in the first step can thereby be periodically purified such as has been described above, and then be brought back in the process in the last step. The fluid filter and the fluid pump may then be placed in the bottom of the device.

1. Gas cleaner for removal of gasborne particles with the aid of a fluid, comprising:
a filter with an inlet and an outlet for contaminated and purified gas, respectively, and a fluid arranged in the filter, wherein gas is sucked or pressed through the filter,
a base chamber with gas inlets equipped with coarse filters,
at least two mixing chambers, wherein each mixing chamber comprises a container with an open top with a central gas outlet and a wall surrounding the gas outlet, to constitute a fluid uptake space between an outer wall of the container, and the wall surrounding the gas outlet,
a cap arranged over said central gas outlet with said cap being arranged to extend downwards into said fluid uptake space, wherein the cap at its lower edge includes an atomizer that creates gas bubbles which together with the fluid forms foam, and
an outlet part in the form of a top piece which comprises a splash filter and a gas outlet opening.

2. Gas cleaner according to claim 1, wherein, seen in the flow direction of the gas, an atomizer provided in an upstream mixing chamber has bigger holes than an atomizer provided in a downstream mixture chamber.

3. Gas cleaner according to claim 1, wherein the fluid is a fluid that does not vaporize at the existing pressure and temperature.

4. Gas cleaner according to claim 1, wherein characterized in that the fluid is water.

5. Gas cleaner according to claim 1, wherein the fluid is water including surface tension reducing agents.

6. Gas cleaner according to claim 1, wherein the fluid is comprised of a non-toxic fluid with equivalent low steam pressure.

7. Gas cleaner according to claim 1, wherein the fluid is an oil or a glycerol.

8. Gas cleaner according to claim 2, wherein the fluid is a fluid that does not vaporize at the existing pressure and temperature.

9. Gas cleaner according to claim 2, wherein the fluid is water,

5. Gas cleaner according to claim 2, wherein the fluid is water including surface tension reducing agents.

6. Gas cleaner according to claim 2, wherein the fluid is comprised of a non-toxic fluid with equivalent low steam pressure.

7. Gas cleaner according to claim 2, wherein the fluid is an oil or a glycerol.
